(19) United States
(12) Patent Application Publication
(10) Pub. No.: US 2025/0361421 A1
(43) Pub. Date: Nov. 27, 2025

(54) BIODEGRADABLE HYDROPHOBIC AND MOISTURE TOLERANT BIO- RESIN PAPER COATING AND METHODS FOR PREPARING SAME

(71) Applicant: COUNCIL OF SCIENTIFIC & INDUSTRIAL RESEARCH, New Delhi (IN)

(72) Inventors: Sushanta Kumar SAHOO, Thiruvananthapuram (IN); P A PARVATHY, Thiruvananthapuram (IN); Ajayaghosh AYYAPPANPILLAI, Thiruvananthapuram (IN)

(73) Assignee: COUNCIL OF SCIENTIFIC & INDUSTRIAL RESEARCH, New Delhi (IN)

(21) Appl. No.: 18/873,408

(22) PCT Filed: Aug. 7, 2023
(86) PCT No.: PCT/IN2023/050758

§ 371 Date: Dec. 10, 2024

(30) Foreign Application Priority Data
Aug. 8, 2022 (IN) 202211045563

(51) Int. Cl. C09D 191/00; D21H 19/10; D21H 21/16

(52) U.S. Cl. CPC C09D 191/00; D21H 19/10; D21H 21/16

(57) ABSTRACT

After ban on single-use plastics, there is a great demand on biodegradable, green and sustainable bio-resin coating to replace the plastics liners for hydrophobic and moisture resistant paper-based packaging. The present invention intends to disclose the process for synthesis of bio-resin starting from epoxides of castor oil and development of coating on cellulosic paper substrate through condensation. The coating is suitable for fatty food and beverages filling and storage. The present invention also disclosed the biodegradability of the coated papers as well as the removal of the coating for reusability of the papers after consumption. The adopted process involves use of green starting material, industrially viable and cost-effective.

### FIELD OF THE INVENTION

The invention is related to the development of hydrophobic and moisture tolerant bio-resin paper coating with repulpable potential. Epoxidized Castor oil has been transesterified and subsequently functionalized with aminosilanes to form low viscous crosslinkable resins and then hydrolysed to condense with hydroxyl groups of cellulosic papers in absence of any catalyst, Moreover, the process is green, industrially viable and cost effective.

### BACKGROUND AND PRIOR ART OF THE INVENTION

Eco-friendly alternative, paper-based packaging provides better solution to the existing single-use plastic menace and support circular economy. Un-coated paper is eco-friendly, biodegradable, and repulpable, but does not provide barrier against moisture and oxygen due to its porous structure and hydrophilic nature. Currently, paper packing applications uses up to 25% petroleum-based plastics to provide desired barrier properties. However, these plastics liners are non-degradable and not recyclable, whereby this applies to the whole laminate. Similarly, biodegradable biopolymeric films (starch, chitosan, cellulose, etc.) are strongly hydrophilic and highly water sensitive, which result in unsatisfactory material performance. A solution provides the development of renewable bio-resin through functionalization of plant oils, in order to replace these plastics liner. The developments could help to replace and reduce the amount of plastics in packaging and to increase the amount of compostable and eco-friendly materials in packaging. The proposed invention can resolve the moisture barrier and biodegradable issues in the papers-based packaging being eco-friendly and sustainable.

Sol-gel method supported by the hydrolysis reaction of an alkoxysilane is the most suitable method for hydrophobic paper coating owing to flexible and strong adhesion, chemically stable and water-repellent, eco-friendly for human being and decomposes in the environment. (Hongmei et al., 2006, Ind. Eng. Chem. Res, 8617-8622, Li et al., 2016 J. Mater. Chem. A, 13677-13725, Iwamiya et al., 2021, Ind. Eng. Chem. Res, 355-360) Crosslinked Silanized plant oils-based coatings display moisture resistant and hydrophobic barrier coating for cellulosic paper substrates. A moisture curable silane modified soybean oil has been developed by reacting unsaturated oil with an unsaturated hydrolysable silane (vinyltrimethoxysilane) in the presence of a free radical initiator for coating on all type of substrates (glass, wood, paper, metal) (Narayan et al, 2010, US20100083871A1). Two component moisture curable coating comprising of silane terminated polyurethane and silanol terminated silaxone has been prepared (Huang et al. 2014, U.S. Pat. No. 8,722,815B2).

Crosslinked silylated soybean oil is coated on kraft paper through condensation polymerization using 3 wt % DBTDL catalyst, in which the WVTR reduced to the tune of 53% (Tambe et al., 2016, Prog. Org. Coatings, 270-278). Similarly, silane grafted epoxidized down-stream corn oil is condensed with hydroxyl functionality of filter paper to reduce the VWTR value (67%) and enhance the hydrophobicity (61° rise in WCA) as compared with uncoated paper (Thakur et al., 2019, ACS Sustain. Chem. Eng. 7 (9), 8766-8774). Researchers also developed bio-coating derived from Palm kernel oil and furfuryl alcohol for paper substrate, which improved the hydrophobic nature and reduced 22% water transmission (Zeng et al., 2020, ACS Appl. Mater. Interfaces 12 (16), 18987-18996). Chitosan-graft-castor oil-based copolymers are developed through chemical grafting of castor oil-capped isocyanate onto the backbone of chitosan and coated on paper to achieve hydrophobicity with WCA of 92° and WVTR value of 734.67 g/m² day (Li et al, 2020, ACS Appl. Polym. Mater 2 (3), 1378-1387). Polysaccharides based oil and grease resistant coating has been developed which enhanced the barrier property of the paper (Williams and Richards, 2015, US2015119505A1).

### Abbreviations Used

EPO—Epoxidized plant oil
EME—Epoxy methyl ester
SME—Silanized methyl ester
APTMS—Aminopropyl trimethoxysilane
PTSA—Paratoluene sulfonic acid
DBTDL—Dibutyltin dilaurate
OOC—Oxirane Oxygen Content
WVTR—Water Vapour Transmission Rate
WCA—Water Contact Angle

### Objectives of the Invention

The primary objective of the present invention is to develop hydrophobic paper coating from castor-based methyl esters which are functionalized with amino silanes and adopting cost effective and eco-friendly method for the synthesis and coating with repulpable potential.

### SUMMARY OF THE INVENTION

In the view background survey of paper coating from renewable materials, the present invention is to develop moisture tolerant paper coatings from silane grafted methyl esters of plant oil such as castor oil.

The current invention describes the preparation of plant oil based methyl esters functionalization with different aminosilanes followed by hydrolysis of silanized methyl esters.

The present invention eliminates the usage of catalyst during hydrolysis as well as crosslinking in comparison to the prior art.

The present invention develops the paper coating with hydrophobicity (WCA) >90° and moisture resistant with 82-85% reduced WVTR value of 100-120 g/m².day.atm.

The present invention reveals the suitability of the coating for filling and storage of fatty food and beverages with migration within prescribed limit

The present invention mentions the biodegradability of the coating and reusability potential of the paper after removal of coating

The current work illustrates the preparation and practical applicability of a novel coating material derived from commercially available methyl esters of epoxidized castor oil which is grafted with Aminopropyltrimethoxysilane (APTMS) using a solvent-free method. Aminosilane grafted ethyl esters of castor oil was hydrolyzed without the use of any external acid or base catalyst and polymerized on cellulosic paper substrate without use of any catalyst or accelerator. Coated materials are adequately hydrophobic, moisture resistant and also biodegradable as per ISO standard. It can be used to fill and store fatty foods and beverages in both cold and hot conditions as validated by USFDA 176.170 and EU10/2011. This coating is a green alternative to existing coating materials due to its biodegradability and repulpable potential after easy removal of coating at pH 10.

### BRIEF DESCRIPTION OF THE FIGURES

FIG. 1 illustrates the synthesis of epoxy methyl esters of castor oil

FIG. 2 illustrates silanization of synthesized epoxy methyl esters

FIG. 3 illustrates the hydrolysis of silanized methyl esters

FIG. 4 illustrates ¹H NMR of epoxy methyl ester of castor oil

FIG. 5 illustrates the ¹H-NMR spectrum of silanized methyl ester

FIG. 6 illustrates FTIR of crosslinked silanol grafted resin on paper

FIG. 7 illustrates the hydrophobicity and reusability potential of paper coating

FIG. 8 illustrates Biodegradation of 250 GSM double side coated paper

### DETAILED DESCRIPTION OF THE INVENTION

This section describes the present invention in preferred embodiments in detail.

According to the prior art, there is a need for renewable polymeric coatings that satisfy qualities such as cost effectiveness, green and sustainability, and reusability. The current invention proposes a low-cost method for making a renewable and biodegradable coating material out of epoxidized castor oil and also with reusability of the paper after use.

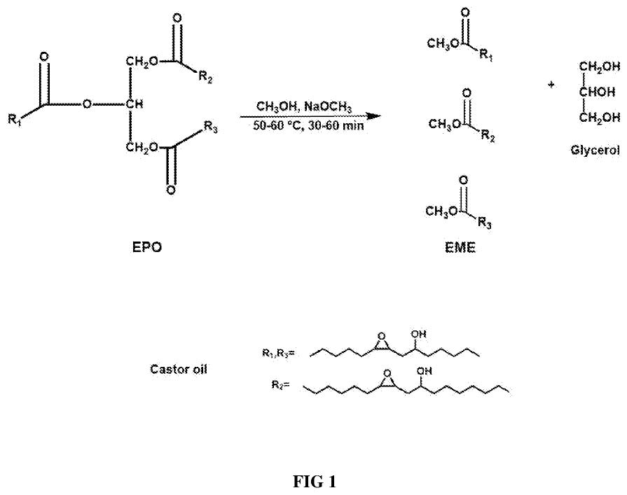

The entire process begins with abundantly available castor oil that has undergone an epoxidation reaction that allows various functionalization. The first step transesterification reaction using sodium methoxide as a base catalyst which removes the glycerol moiety from the epoxidized oil, resulting in formation of low viscous epoxy methyl ester (FIG. 1) with improved reactivity.

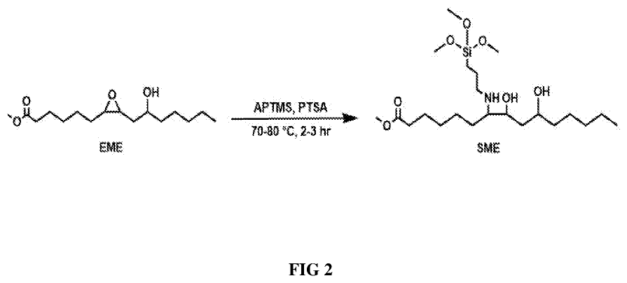

The second step entails grafting amino silane (APTMS) to epoxy methyl ester of castor oil (EME) (FIG. 2). Silane grafting improves hydrophobic and moisture resistant property, and it is incorporated into the bio-resin moiety via a ring opening reaction at the epoxide site in presence of PTSA as catalyst. Transesterification increased the reactivity of epoxidized bio-resin by reducing steric hindrance.

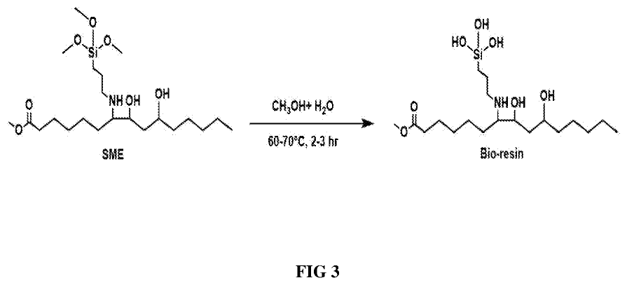

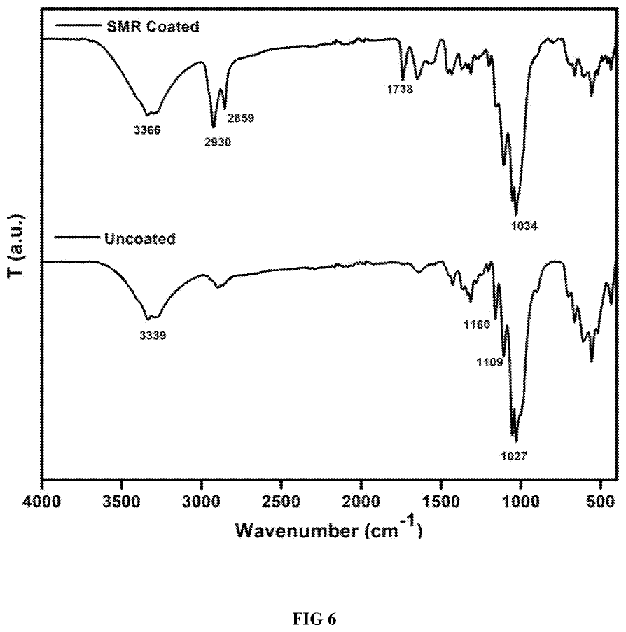

Silanized methyl esters undergoes hydrolysis (FIG. 3) in presence of an alcohol and water to produce hydrolysed silanol grafted resin as coating material. Stability of hydrolysed resin is crucial with respect to pH, as there is need to inhibit self-condensation reaction of silanol to siloxane. In contrast to prior art, the acid-based catalysts are not used in the hydrolysis reaction. The hydrolysed resins are coated on paper substrate through dip coating and dried at 120-150° C. for 1-3 hours for condensation or complete crosslinking confirmed by spectroscopy (FIG. 6)

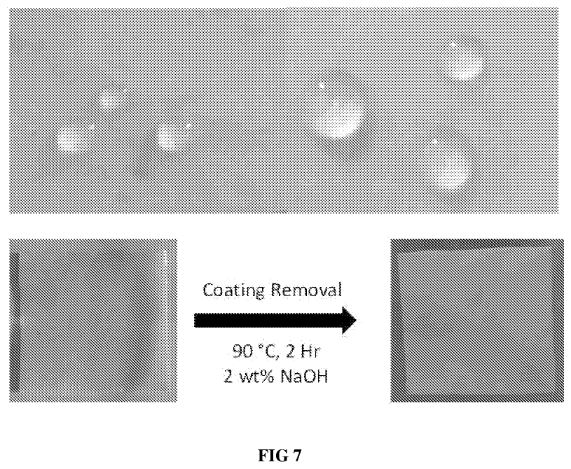

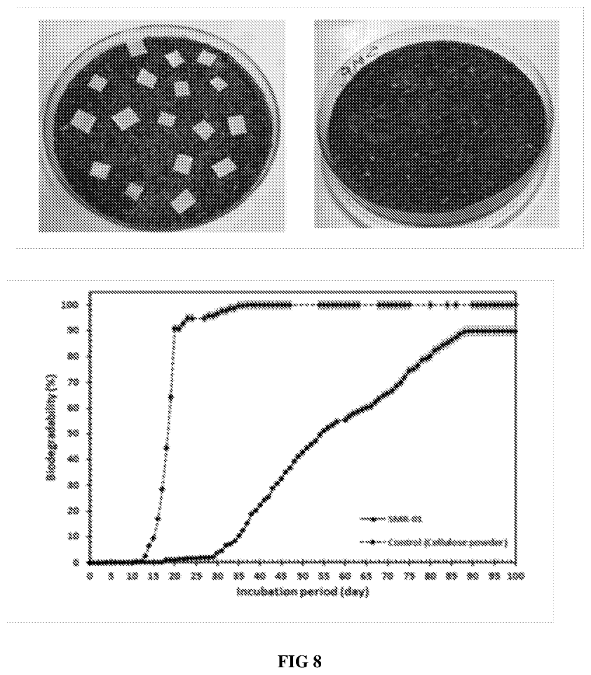

The coatings exhibit contact angle of 90-95 degrees, which is an appropriate value for water resistant hydrophobic coatings. According to prior art, the majority of coatings are not repulpable. Coatings in the current invention are repulpable in nature and can be removed in a pH 10-11 at 70-90° C. (FIG. 7). Further, the coatings are biodegradable in aerobic composting condition and found to degrade 90% in 87-90 days as per ISO14855-2:2018 (FIG. 8).

The coatings exhibit contact angle of 90-95 degrees (TABLE 1), which is an appropriate value for hydrophobic coatings. WVTR data is found to be in a range of 100-120 gm/m2. day.atm and moisture of 1-2% which is satisfactory for paper coatings for packaging (TABLE 1). The results of the eco-toxic metal leaching in soil after degradation are within or below detection limit for all heavy toxic metals such as mercury, cadmium, lead, and so on (TABLE 2) and specific migration test results for toxic substances are also within the limit or not detected (TABLE 3). Further over all migration testing was performed, and the values were found to be within the limitations stipulated in USFDA 176:170 1st April 2019, for intended usage in contact with fatty foods/beverages at room temperature and hot temperature filling and storing (TABLE 4).

TABLE 1
Illustrates Contact angle, WVTR and moisture
content before and after coating

| | Uncoated | Coated paper with |
|---|---|---|
| Parameter | paper | APTMS grafting |
| WVTR (g/m² · day · atm) | 600-650 | 100-120 |
| Contact angle (° C.) | 0-5 | 90-95 |
| Moisture (%) | 7-9 | 1-2 |

TABLE 2
Illustrates Eco-toxicity-heavy metal test of soil after degradation

| | Test | | Permissible | |
|---|---|---|---|---|
| | results, | Permissible | limit for | |
| | Concen- | limit for | drinking | |
| | tration, | leaches | water | |
| Heavy metals | (ppm) | (ppm) | (ppm) | Remarks |
| Arsenic (As) | BDL* | 0.2 | 0.01 | BDL* |
| Copper (Cu) | 0.011 | 3.0 | 0.05 | Within |
| | | | | limit |
| Nickel (Ni) | BDL* | 3.0 | — | BDL* |
| Zinc (Zn) | 0.003 | 5.0 | 5.0 | Within |
| | | | | limit |
| Cobalt (Co) | BDL* | — | — | BDL* |
| Chromium (Cr) | BDL* | 2.0 | 0.05 | BDL* |
| Molybdenum | BDL* | — | — | Limit not |
| (Mo) | | | | specified |
| Mercury (Hg) | BDL* | 0.01 | 0.001 | BDL* |
| Cadmium (Cd) | BDL* | 2.0-1.0 | 0.01 | BDL* |
| Lead (Pb) | BDL* | 0.1-1 | 0.05 | BDL* |
| Selenium (Se) | BDL* | — | — | BDL* |
| Silver (Ag) | BDL* | — | — | BDL* |
| Strontium (Sr) | BDL* | — | — | Limit not |
| | | | | specified |
| Manganese (Mn) | BDL* | — | — | Limit not |
| | | | | specified |
| Magnesium (Mg) | 0.010 | — | — | Limit not |
| | | | | specified |
| pH | 6.81 | 5.5-9.0 | 6.5-8.5 | Within |
| | | | | limit |

TABLE 3
Illustrates Specific migration test for toxic substances

| Sl. | | Test | | Specified | | Results |
|---|---|---|---|---|---|---|
| No | Name of the Test | Method | Unit | Requirement | | obtained |
| 1. | Specific Migration | EU | | | | |
| (a) | Cadmium | 10/2011 | mg/kg | 0.002 | (Max) | 0.0008 |
| (b) | Cobalt | | mg/kg | 0.05 | (Max) | 0.0002 |
| (c) | Copper | | mg/kg | 5 | (Max) | 0.0016 |
| (d) | Iron | | mg/kg | 48 | (Max) | 0.0009 |
| (e) | Chromium | | mg/kg | 0.01 | (Max) | 0.0002 |
| (f) | Manganese | | mg/kg | 0.6 | (Max) | 0.0003 |
| (g) | Mercury | | mg/kg | 0.01 | (Max) | Not |
| | | | | | | detected |
| (h) | Lead | | mg/kg | 0.01 | (Max) | 0.0003 |
| (i) | Zinc | | mg/kg | 25 | (Max) | 0.0005 |

| | | | | |
|---|---|---|---|---|
| (j) | Silicon | mg/kg | — | 0.0002 |

TABLE 4
Illustrates Over all migration test for food contact

| | | | Limits | |
|---|---|---|---|---|
| | | | as per | |
| | | Amount of | USFDA- | |
| Test | Simulant | Extractives | 176.170 | |
| Parameter | (Temp/Time) | mg/in² | mg/in² | Test Method |
| Global | n-Heptane | 0.027 | 0.5 | USFDA- |
| Migration | (21° C./ | | | 176.170 |
| test | 0.5 hrs.) | | | 1^{st} Apr. 2020 |
| | n-Heptane | 0.038 | | |
| | (49° C./ | | | |
| | 0.5 hrs.) | | | |

### Examples

### Example 1. Synthesis of Epoxy Methyl Ester (EME)

EPO (Epoxidized castor oil) (OOC ≥3.5%, Jayant Agro organic Pvt. Ltd. Mumbai), ECO is procured from Jayant Agro-Organic Ltd, Mumbai, India and the oils used by the industry has been procured from Ihsedu Agrochem Pvt. Ltd located in Gujarat and the castor seeds are cultivated in India.

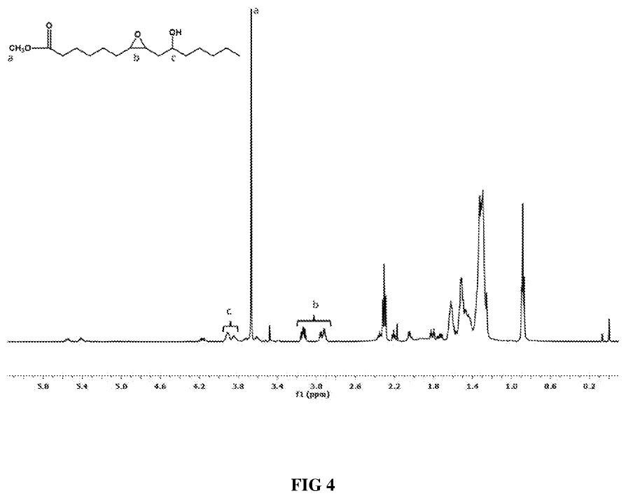

50 g of ECO, sodium methoxide (1 wt % catalyst) and 15 ml alcohol were added to a single-necked RB (250 ml) equipped with a reflux condenser and magnetic stirrer. Transesterification was performed at 50-60° C. for 30-60 minutes. When the reaction was finished, the reaction mixture separated into two layers (the sedimented layer is the glycerol and the methyl esters on the top). A rotary evaporator was used to extract alcohol from EME (a less viscous light yellow liquid form). 1H NMR (CDCl3, 500 MHz) of Epoxy methyl esters of castor oil (EME) (FIG. 4): δ 3.65 (CH3OC═O, intense), disappearance of 4.1-4.2 (—CH2 of glycerol moity) and 5.25 (—CH of glycerol), 2.9-3.1 (retained epoxide CH—O—CH).

### Example 2. Synthesis of Silanized Epoxy Methyl Ester (SME)

EME were silanized utilizing a solvent-free process. 40 g EME was taken in a two-neck RB outfitted with a condenser, nitrogen inlet, and magnetic stirrer. The silanizing agent amino propyl trimethoxy silane (APTMS) was added in a 1:1-1:1.5 ratio and agitated for 10-15 minutes at 70-80° C. before the catalyst PTSA (10-15 mol percent) was added. The reaction was carried out for 2-3 hours at 70-80° C. in an inert environment. The silane-modified resin was employed for further characterization and application. The silyl grafting was 0.74 and 0.82 for 10% and 15% PTSA respectively.

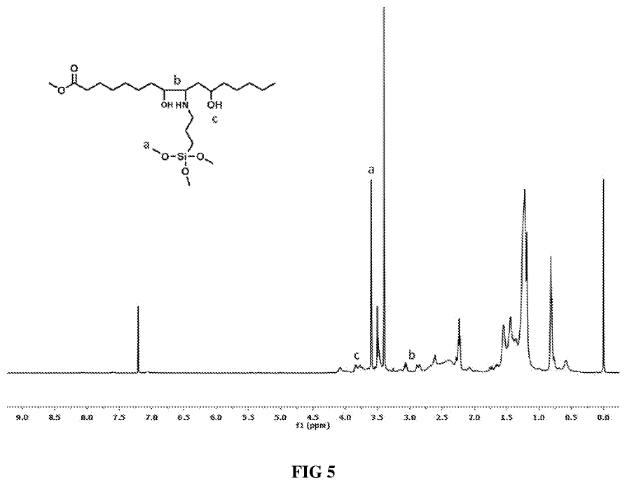

1H NMR (CDCl3, 500 MHz) of SME (FIG. 5): δ 3.59 (alkyl portions of silane), 2.88-3.06 (intensity of epoxide proton signal reduced), 3.8 (—OH).

### Example 3. Hydrolysis of SME and Coating Process

SME was hydrolyzed with a methanol-water combination without using any acid catalyst. The hydrolysis was carried out in an aqueous solution with a pH of 10-11 for greater stability, and the silane molecules were condensed in a slightly neutral pH to balance the hydrolysis and condensation reactions. SME (50 g) was combined with alcohol and water (1:1 to 3:1). After 10-15 minutes of stirring, extra alcohol was added and the mixture was swirled for another 2-3 hours at 60-70° C. After 2-3 hours, homogeneous solutions were obtained. The hydrolyzed resin was coated on paper with 11 micron pores using a casting process and cured at 150° C. for 1-2 hrs. IR analysis of SME coated paper (FIG. 6)—confirms the crosslinking of silanol with hydroxyl groups of paper. The peak corresponds to Si—O—Si stretching in the uncoated paper got broadened in coated paper. The intensity of O—H stretching vibrations in cellulose at 3000-3200 cm1 reduced in coated paper due to grafting of Silanol to form Si—O—C bond.

### Example 4. Characterization and Evaluation of Properties

FTIR spectrophotometer (PerkinElmer) in ATR mode and 1 H NMR (500 MHz Bruker Advance DPX spectrometer) are used to take spectra to confirm the functionality grafted to the bioresin. Moisture content and WVTR values coated samples are evaluated as per ASTM D644 and ASTM E96 respectively. Contact angle of the uncoated and coated papers are determined through Sissel-drop method taking 2 μl drop water on the coated surface Removal of coating from paper is carried out by treating with 2 wt % NaOH at 90° C. to explore the reusability. Biodegradability and eco-toxicity heavy metal analysis is done as per ISO14855-2:2018 and ASTM D3987-12 respectively. USFDA 176.170 and EU10/2011 are adopted for overall migration and specific migration of the coated samples.

### Advantages of the Invention

Solvent free method was adopted for the silanization process
Hydrolysis and polymerization were carried out without using external DBTDL catalyst
Hydrophobic coating achieved with water contact angle >90° and comparable WVTR value as bioplastics and reduced moisture content
The coating is suitable for filling and storage of food and beverages in hot and cold conditions as per USFDA 176.170 standard
The coating is compostable in aerobic conditions and the paper is repulpable

We claim:

1. A process for making biodegradable, moisture resistant and hydrophobic bioresin coating on paper comprising the steps of;
(a) performing epoxidation reaction of castor oil to form epoxide castor oil;
(b) transesterification reaction of epoxidized castor oil as obtained in step (a) by using base catalyst to obtain epoxy methyl ester;
(c) grafting aminopropyl trimethoxy silane to epoxy methyl ester of castor oil in the presence of catalyst to obtain silanized methyl ester;
(d) hydrolyzing the silanized methyl ester as obtained in step (c) in the presence of alcohol and water to produced silanol grafted resin;
(e) coating of cellulosic paper with silanol grafed methyl ester as obtained in step (d) for condensation or crosslinking.

2. The process as claimed in claim 1, wherein the base catalyst is sodium methoxide.

3. The process as claimed in claim 1, wherein the catalyst is paratoluene sulfonic acid.

4. The process as claimed in claim 1, wherein the alcohol is methanol.

5. The process as claimed in claim 1, wherein silyl grafting through ring opening of epoxy is carried out by reacting with amino trialkoxy silanes preferably amino propyl trimethoxy silane by maintaining epoxy: amine molar ratio in the range of 1:1 to 1:1.5.

6. The process as claimed in claim 1, wherein the catalyst is provided in the range of 10 to 15 molar percent and the reaction temperature is in the range 70-80° C. for 2-3 hr.

7. The process as claimed in claim 1, wherein the hydrolysis is carried out in absence of acids.

8. The process as claimed in claim 1, wherein the ratio of alcohol and water is in the range of 1:1 to 3:1.

9. The process as claimed in claim 1, wherein hydrolysis is maintained in aqueous solution of pH 10-11 and the condensation is done in slightly neutral pH 7.

10. The process as claimed in claim 1, wherein the complete crosslinking of the bio-resin is carried out at 150° C. for 1-2 hrs without using any catalyst.

11. The process as claimed in claim 1, wherein the bioresin coating is hydrophobic with water contact angle of 90-95° and moisture resistant with reduced water vapour transmission rate by 82-85%.

12. The process as claimed in claim 1, wherein the coating is biodegradable within 90-100 days under aerobic composting conditions as per ISO14855-2:2018

13. The process as claimed in claim 1, wherein the coating is removable when treated with alkali solution of pH 10-12 at 90° C. and papers are repulpable.

14. The process as claimed in claim 1, wherein the coatings are suitable for fill and storage of fatty foods and beverages at cold and hot temperature with overall and specific migration values with limits as per the USFDA 176.170 and EU 10/2011
